(19) United States
(12) Patent Application Publication
(10) Pub. No.: US 2015/0330815 A1
(43) Pub. Date: Nov. 19, 2015

(54) PROXIMITY SENSOR COVER

(71) Applicant: MICHAEL DEVON LOUDEN, North Fort Myers, FL (US)

(72) Inventor: MICHAEL DEVON LOUDEN, North Fort Myers, FL (US)

(21) Appl. No.: 14/277,439

(22) Filed: May 14, 2014

(51) Int. Cl. G01D 11/24

(52) U.S. Cl. CPC G01D 11/245

(57) ABSTRACT

In a proximity-based water valve system having a housing and a proximity sensor, a sensor cover includes a planar main body formed of a translucent and/or opaque material, and an extension handle connected to the main body, which can be adhered to the housing and/or proximity sensor via an adhesive area on a rear side of the main body, such that the main body covers the proximity sensor with the extension handle being angled away from the proximity sensor.

### FIELD OF THE INVENTION

The present invention relates to plumbing fixtures, and more specifically, to plumbing fixtures having a proximity-based valve control system.

### BACKGROUND OF THE INVENTION

Plumbing fixtures, such as faucets and toilets, for example can include valves to supply water for general uses, such as for washing and flushing purposes. For convenience and/or conservation purposes, plumbing fixtures can include proximity-based valve control systems, which can include a proximity sensor that causes a water valve to open and/or close when a person or object is close to and/or moves away from the proximity sensor. A common proximity sensor utilized in this regard can be a photosensor.

### SUMMARY OF THE INVENTION

The present invention provides a sensor cover utilized within a proximity-based water valve system having a housing and proximity sensor adjacent to the housing. Such a sensor cover can include a planar main body and an extension handle connected to the main body. The main body, can be formed of at least one of a translucent material and an opaque material, and can include a front main body side and a rear main body side. The rear main body side can include an adhesive area, such that the main body can be adhered to at least one of the housing and the proximity sensor such that the main body covers the proximity sensor with the extension handle extending away from the proximity sensor.

In an exemplary aspect of the present invention, the main body is adhered to the housing and/or the proximity sensor by the adhesive area contacting the housing and/or proximity sensor, such that the main body covers the proximity sensor with the extension handle being angled away from the proximity sensor.

In another exemplary aspect of the present invention, after such an adhesion, the translucent and/or opaque material(s) blocks light waves from reaching and triggering the proximity sensor, so as to deactivate the sensor.

In yet another exemplary aspect of the present invention, after such an adhesion, a user can pull the extension handle to remove the sensor, so as to enable the sensor.

In a further exemplary aspect of the present invention, the adhesive area can include an adhesive material, which can be applied to at least a portion of the rear main body side.

In still a further exemplary aspect of the present invention, the rear main body side can be formed from the adhesive material.

In still another exemplary aspect of the present invention, the main body and the extension handle can defined at least in part by a crease.

In yet another exemplary aspect of the present invention, the extension handle can be attached to any portion of the main body via an adhesive material or structural element, such as a staple for example and not in limitation.

### BRIEF DESCRIPTION OF THE DRAWINGS

FIG. 1 illustrates an exemplary environment of the present invention, in which a proximity-based water valve system 10 can be utilized with a conventional toilet 20.

FIG. 2a illustrates a perspective of an exemplary sensor cover 1 having a planar main body 100, a front main body side 102, and an extension handle 104.

FIG. 2b illustrates another perspective of an exemplary sensor cover 1 having a rear main body side 106 with an adhesive area 108.

FIG. 3a is an exploded perspective of an exemplary sensor cover 1 with an exemplary proximity-based valve system 10 having a housing 12 and a proximity sensor 14 adjacent to the housing.

FIG. 3b illustrates an exemplary adhesion of sensor cover 1 to housing 12 and/or proximity sensor 14 with extension handle 104 angled away from sensor 14.

FIG. 4 illustrates an exemplary sensor cover 1 having a visual representation 130 on the front main body side 114.

### DETAILED DESCRIPTION

It is an object of the present invention to provide a sensor cover having a plurality of embodiments, which are described, and are to be broadly interpreted, via the disclosure herein.

It should be noted that this disclosure includes a plurality of embodiments each having a plurality of elements and/or aspects, and such elements and/or aspects need not necessarily be interpreted as being conjunctively required by one or more embodiments of the present invention. In particular, all combinations of elements and/or aspects can enable a separate embodiment of a patentable invention, which may be claimed with particularity in this or any future filed Patent Applications. Moreover, such elements and/or aspects disclosed herein, whether expressly or implicitly, are to be construed strictly as illustrative and enabling, and not necessarily limiting. Therefore, it is expressly set forth that any elements and/or aspects, independently or in any combination of one of more thereof, are merely illustratively representative of one or more embodiments of the present invention and are not to be construed as necessary in a strict sense.

Further, to the extent the same element and/or aspect is defined differently anywhere within this disclosure, whether expressly or implicitly, the broader definition is to take absolute precedence, with the distinctions encompassed by the narrower definition to be strictly construed as optional.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention.

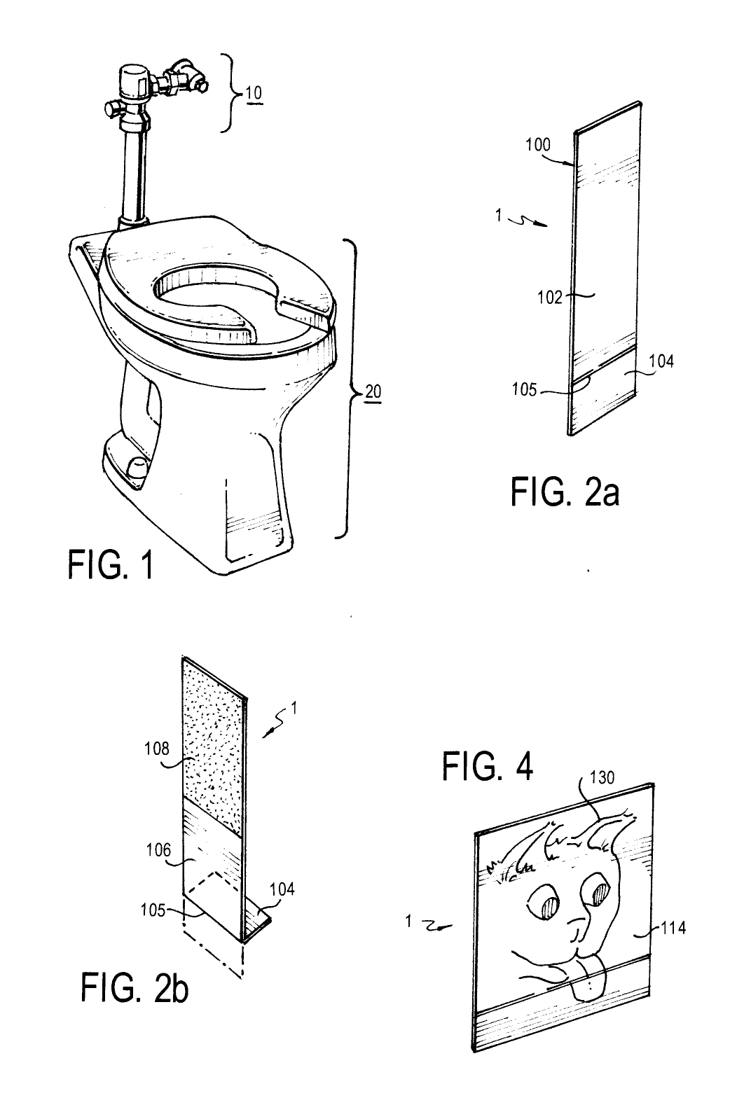

FIG. 1 illustrates an exemplary environment of the present invention, in which a proximity-based water valve system 10 can be utilized with any type of plumbing fixture 20, such as a conventional toilet, faucet, etc., for example and not in limitation.

As illustrated in FIGS. 2a and 2b, in an exemplary embodiment of the present invention, a sensor cover 1 can include a planar main body 100 and an extension handle 104 connected to the main body. Notably, extension handle 104 can be connected to main body 100 via attachment (e.g., via an adhesive, staple, etc.) or via at least one crease 105 (e.g., handle 104 can be integral with main body 100, etc.). Further, while handle 104 is illustratively shown to connected at a terminal portion of main body 100, the handle can connected to any desired portion or side of main body 100 insofar as functionally compatible with the present invention.

In an exemplary aspect of the present invention, main body 100 can be formed of at least one of a translucent material and an opaque material, such as a plastic, rubber, metal, wood, or any other man-made or naturally occurring material, which can block at least a majority of light from passing through the main body. For example, such a material can reflect or absorb the at least a majority of light. Further, main body 100 can include a front main body side 102 and a rear main body side 106, with the rear side having an adhesive area 108. Notably, adhesive area 108 can include an adhesive material, such as a glue or any other “sticky or tacky” substance, for example and not in limitation. Alternatively or conjunctively, rear main body side 106 can be formed from an adhesive material that can provide an adhesion force when in contact with another material. For example and not in limitation, rear main body side 106 can be formed from a polyvinyl chloride or a low density polyethylene. Also notably, adhesive area 108 can be provided in any desired functionally-compatible geometric shape, whether symmetric or asymmetric, and further, can be provided in one or more sections making-up or covering at least a portion of rear main body side 106.

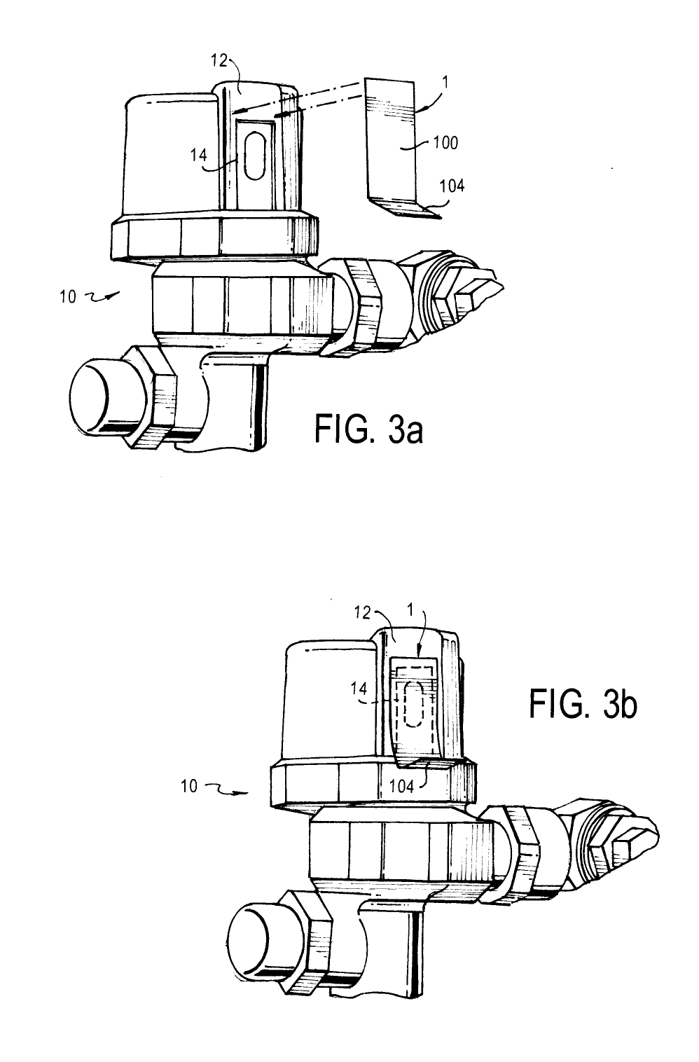

FIG. 3a illustrates an exemplary utilization of the present invention, in which a sensor cover 1 can be adhered to at least one of the housing 12 and the proximity sensor 14 of proximity-based water valve system 10 by pressing the adhesive area 108 (not shown) against the housing and/or proximity sensor. As illustratively shown in FIG. 3b, when properly positioned, main body 100 at least substantially covers proximity sensor 14 with extension handle 104 being angled away from the proximity sensor. Accordingly, main body 100 can then block at least a majority of light from reaching proximity sensor 14, which can effectively disable the same. Notably, after sensor cover 1 is so positioned, extension handle 104 can be subsequently grasped and pulled to remove the cover, which can expose sensor 14 and re-enable the same. Also notably, incorporation and use of extension handle 104 can allow removal of sensor cover 1 without requiring a user to physically contact any portion of proximity-based water valve system 10 or plumbing fixture 20, either of which may be, or be perceived as being, unsanitary.

FIG. 4 illustrates an exemplary sensor cover 1 having an informational portion 130, which is illustratively shown as an image, but can be any one or more of text, a picture, a design, an image, a raised portion, and a depressed portion. Further, informational portion 130 can be provided via printing, attaching a printed portion, forming (e.g., molding, etc.), attaching a formed portion, etching, irradiating, or any other manner of providing visual or tactile-based information, such as Braille, for example and not in limitation.

It should be noted that each element and/or aspect of the embodiments described herein is expressly set forth as being potentially independently patentable without requiring another. Therefore, the inventor does not waive the right to seek patent protection for all combinations of one or more thereof.

Notably, in any embodiment of the present invention, the various elements can be provided in any desired shape and/or size that are functionally compatible with the present invention as described and/or claimed, and as expressly stated, are not limited to any particular shape or size illustratively described herein or apparent herefrom. Accordingly, exemplary shapes and/or sizes can include any shape or size having one or more geometric shapes, whether having symmetric or asymmetric portions, and without shape or size limitations relative to other elements unless necessary to the functionality of the present invention.

Further, it is expressly set forth that any structural element and/or aspect described herein can be formed from any one or more desired materials that provide functional compatibility with the respective component and/or the respective aspect related thereto. Thus, any one or more of a plastic, rubber, metal, wood, elastomer, crystalline material, man-made material, naturally-occurring material, synthetic, etc. may be utilized insofar as respectively compatible.

It will be apparent to one of ordinary skill in the art that the manner of making and using the claimed invention has been adequately disclosed in the above-written description of the exemplary embodiments and aspects.

It should be understood, however, that the invention is not necessarily limited to the specific embodiments, aspects, arrangement, and components shown and described above, but may be susceptible to numerous variations within the scope of the invention. For example, while the present invention has been described as blocking light with respect to a light-detecting proximity sensor, such a sensor cover can be utilized to block other physical measurements with respect to other proximity sensors, such as sound-, infra-red, and capacitive-based sensors. Accordingly, main body 100 can be formed from particular materials that block or “flood” respectively sensed data, such as blocking audible sound or capacitive changes, or maintaining a sensed data level at a low or high level, for example and not in limitation.

Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents of the appended claims.

Therefore, I claim:

1. In a proximity-based water valve system having a housing and a proximity sensor adjacent to the housing, a sensor cover, comprising:
a planar main body formed of at least one of a translucent material and an opaque material, said main body including a front main body side, and a rear main body side having an adhesive area; and
an extension handle connected to said main body;
wherein said main body is adhered to at least one of the housing and the proximity sensor by the adhesive area contacting the at least one of the housing and the proximity sensor, such that said main body covers the proximity sensor with said extension handle angled away from the proximity sensor.

2. The sensor of claim 1, wherein the adhesive area includes an adhesive material.

3. The sensor of claim 2, wherein the adhesive material is applied to at least a portion of the rear main body side.

4. The sensor of claim 1, wherein the rear main body side is formed from the adhesive material.

5. The sensor of claim 1, wherein said main body and said extension handle are defined at least in part by at least one crease.

6. The sensor of claim 1, wherein said extension handle is attached to said main body.

7. The sensor of claim 1, wherein said extension handle is attached to said main body via an adhesive.

8. The sensor of claim 1, wherein said extension handle is connected to a terminal edge of said main body.

9. The sensor of claim 1, wherein said extension handle is connected between opposing first and second terminal edges of said main body.

10. The sensor of claim 1, wherein the front main body side includes a decorative portion.
